(19) United States
(12) Patent Application Publication
(10) Pub. No.: US 2015/0081823 A1
(43) Pub. Date: Mar. 19, 2015

(54) Terminal Search Method and Apparatus

(71) Applicant: Huawei Device Co., Ltd., Shenzhen (CN)

(72) Inventors: Wenmei Gao, Beijing (CN); Zhiming Ding, Shenzhen (CN); Guiming Shu, Shenzhen (CN); Huangwei Wu, Shenzhen (CN); Lei Wang, Beijing (CN)

(21) Appl. No.: 14/550,035

(22) Filed: Nov. 21, 2014

Related U.S. Application Data
(63) Continuation of application No. PCT/CN2013/075924, filed on May 20, 2013.

(30) Foreign Application Priority Data
May 21, 2012 (CN) 201210157847.1

(51) Int. Cl. G06F 17/30; H04W 4/12

(52) U.S. Cl. CPC G06F 17/30943; H04W 4/12
USPC 709/206; 707/722

(57) ABSTRACT

A terminal search method and apparatus are disclosed that relate to the field of wireless communications technologies and resolve a problem in the prior art that a terminal cannot find, without relying on support from a Location Based Service (LBS) server, another terminal that runs a same application in a local scope or an adjacent area. The method includes acquiring an application identifier; broadcasting a broadcast frame that carries the application identifier to a receiving end; receiving a message that is sent by a candidate receiving end and carries a target application identifier, where the target application identifier is selected by the candidate receiving end from the application identifier; and determining a target receiving end from the candidate receiving end, so as to establish a connection of a target application with the target receiving end. Embodiments of the present invention are mainly applied to a short-distance wireless communication process.

### CROSS-REFERENCE TO RELATED APPLICATION

This application is a continuation of International Application No. PCT/CN2013/075924, filed on May 20, 2013, which claims priority to Chinese Patent Application No. 201210157847.1, filed with the Chinese Patent Office on May 21, 2012, both of which are hereby incorporated by reference in their entireties.

### TECHNICAL FIELD

The present invention relates to the field of wireless communications technologies, and in particular, to a terminal search method and apparatus.

### BACKGROUND

The Wireless Fidelity Direct (Wi-Fi Direct) standard refers to allowing devices on a wireless network to connect to each other without a need of a wireless router. Similar to the BLUETOOTH technology, this standard allows wireless devices to connect to each other in a point-to-point manner, but it improves significantly in terms of a transmission speed and a transmission distance compared with the BLUETOOTH technology. The Wi-Fi Direct standard is oriented at a variety of Wireless Fidelity (Wi-Fi) devices, including a computer, a mobile phone, a computer peripheral, a household appliance, and the like. A device complying with the standard can conveniently and directly connect to another device for data transmission or application sharing without a need of a hot spot or a router. The Wi-Fi Direct can support a one-to-one direct connection and can also implement simultaneous connections of multiple devices. In addition, the Wi-Fi Direct standard supports all Wi-Fi devices, from 11a/b/g to 11n, and Wi-Fi devices of different standards can also directly connect to each other.

The BLUETOOTH Special Interest Group (BLUETOOTH SIG) formally issues a new generation standard specification BLUETOOTH Core Specification Version 3.0 High Speed. This is a new alternate radio frequency technology that allows a BLUETOOTH protocol to dynamically select a correct radio frequency for any task. High-speed transfer of a large amount of data by using BLUETOOTH 3.0 inevitably consumes more energy. However, because of introduction of an enhanced power control (EPC) mechanism and supplementation of 802.11, actual idle power consumption is significantly reduced, and therefore the BLUETOOTH 3.0 can be easily used for document transmission from a video recorder to a high-definition television (TV), from a computer to a portable media player (PMP), and from a ultra-mobile personal computer (UMPC) to a printer.

In the prior art, social applications are all based on the Location Based Service (LBS) technology. That is, support from a mobile network and the Global Positioning System (GPS) is required, and support from an LBS server is required. Without relying on the support from the LBS server, a terminal cannot find another terminal that runs a same application in a local scope or an adjacent area (in a BLUETOOTH or Wi-Fi scope). As a result, data exchange cannot be implemented between terminals in the local scope or the adjacent area.

### SUMMARY

Embodiments of the present invention provide a terminal search method and apparatus, so that a terminal can pertinently find, without support from an LBS server, another terminal that runs a same application or service, thereby implementing mobile data exchange between terminals.

The present invention adopts the following technical solutions.

A terminal search method includes acquiring an application identifier; broadcasting a broadcast frame that carries the application identifier to a receiving end; receiving a message that is sent by a candidate receiving end and carries a target application identifier, where the target application identifier is selected by the candidate receiving end from the application identifier; and determining a target receiving end from the candidate receiving end, so as to establish a connection of a target application with the target receiving end.

A terminal search method includes receiving a broadcast frame that is broadcast by a sending end and carries an application identifier; determining a target application identifier from the application identifier, where an application corresponding to the target application identifier is in an active state on a receiving end; and sending a message that carries the target application identifier to the sending end, so as to establish a connection of the target application with the sending end.

A sending end includes an application register service module and includes an acquiring unit configured to acquire an application identifier; a broadcasting unit configured to broadcast a broadcast frame that carries the application identifier to a receiving end; a receiving unit configured to receive a message that is sent by a candidate receiving end and carries a target application identifier, where the target application identifier is selected by the candidate receiving end from the application identifier; and a processing unit configured to determine a target receiving end from the candidate receiving end, so as to establish a connection of a target application with the target receiving end.

A receiving end includes an application register service module and includes a receiving unit configured to receive a broadcast frame that is broadcast by a sending end and carries an application identifier; a searching unit configured to determine a target application identifier from the application identifier, where an application corresponding to the target application identifier is in an active state on the receiving end; and a sending unit configured to send a message that carries the target application identifier to the sending end, so as to establish a connection of the target application with the sending end.

In the terminal search method and apparatus provided in the embodiments of the present invention, an application identifier of a sending end is acquired; a broadcast frame that carries the application identifier is sent; a receiving end receives the broadcast frame and searches, among applications on the receiving end, for a same application that corresponds to the application identifier in the broadcast frame, where the same application is in an active state on the receiving end, and the same application identifier is a target application identifier; the sending end receives messages that are sent by candidate receiving ends and carry target application identifiers of the candidate receiving ends, and determines a target receiving end from the candidate receiving end; and the sending end establishes a connection of the target application with the target receiving end. In the embodiments of the present invention, a problem in the prior art that a terminal cannot find, without relying on support from an LBS server, another terminal that runs a same application in a local scope or an adjacent area (in a BLUETOOTH or Wi-Fi scope) is resolved, so that a terminal can pertinently find, without an LBS server, another terminal that runs a same application or service, thereby implementing mobile data exchange between terminals.

### BRIEF DESCRIPTION OF THE DRAWINGS

FIG. 1 is a flowchart of a terminal search method according to Embodiment 1 of the present invention;

FIG. 2 is a flowchart of a terminal search method according to Embodiment 1 of the present invention;

FIG. 3 is a scenario instance of Wi-Fi device discovery according to Embodiment 2 of the present invention;

FIG. 4 is a flowchart of a terminal search method according to Embodiment 2 of the present invention;

FIG. 5 is a schematic diagram of a format of a probe request frame according to Embodiment 2 of the present invention;

FIG. 6 is a structural diagram of an application identifier element in a probe request frame according to Embodiment 2 of the present invention;

FIG. 7 is a schematic diagram of content included in an application identifier structure in a probe request frame according to Embodiment 2 of the present invention;

FIG. 8 is a structural diagram of an application identifier result extended in a probe response frame according to Embodiment 2 of the present invention;

FIG. 9 is a schematic diagram of content included in an application identifier matching result structure extended in a probe response frame according to Embodiment 2 of the present invention;

FIG. 10 is a flowchart of another terminal search method according to Embodiment 2 of the present invention;

FIG. 11 is a flowchart of still another terminal search method according to Embodiment 2 of the present invention;

FIG. 12 is a flowchart of yet another terminal search method according to Embodiment 2 of the present invention;

FIG. 13 is a structural diagram of a sending end according to Embodiment 3 of the present invention;

FIG. 14 is a structural diagram of another sending end according to Embodiment 3 of the present invention;

FIG. 15 is a structural diagram of still another sending end according to Embodiment 3 of the present invention;

FIG. 16 is a structural diagram of yet another sending end according to Embodiment 3 of the present invention;

FIG. 17 is a structural diagram of yet another sending end according to Embodiment 3 of the present invention;

FIG. 18 is a structural diagram of yet another sending end according to Embodiment 3 of the present invention;

FIG. 19 is a structural diagram of a receiving end according to Embodiment 3 of the present invention;

FIG. 20 is a structural diagram of another receiving end according to Embodiment 3 of the present invention;

FIG. 21 is a structural diagram of still another receiving end according to Embodiment 3 of the present invention;

FIG. 22 is a structural diagram of yet another receiving end according to Embodiment 3 of the present invention;

FIG. 23 is a structural diagram of yet another receiving end according to Embodiment 3 of the present invention; and

FIG. 24 is a structural diagram of a searching unit in a receiving end according to Embodiment 3 of the present invention.

### DETAILED DESCRIPTION

The following describes a terminal search method and apparatus in embodiments of the present invention in detail with reference to accompanying drawings.

### Embodiment 1

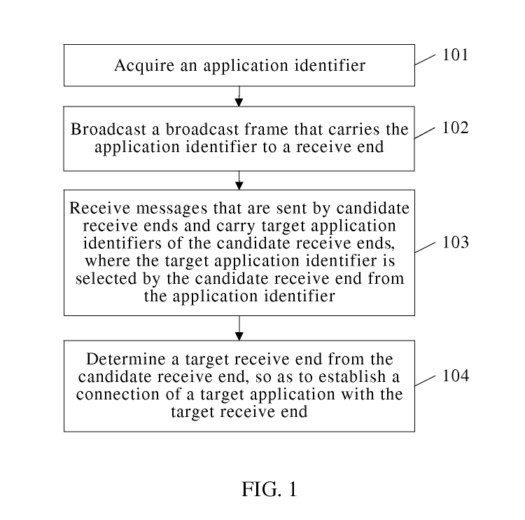

This embodiment of the present invention provides a terminal search method. As shown in FIG. 1, the method includes the following steps.

101. Acquire an application identifier.

102. Broadcast a broadcast frame that carries the application identifier to a receiving end.

103. Receive messages that are sent by candidate receiving ends and carry target application identifiers of the candidate receiving ends, where the target application identifier is selected by the candidate receiving end from the application identifier.

104. Determine a target receiving end from the candidate receiving end, so as to establish a connection of a target application with the target receiving end.

In the terminal search method provided in this embodiment of the present invention, an application identifier of a sending end is acquired; a broadcast frame that carries the application identifier is broadcast to a receiving end; the sending end receives messages that are sent by candidate receiving ends and carry target application identifiers of the candidate receiving ends, where the target application identifier is selected by the candidate receiving end from the application identifier; and the sending end determines a target receiving end from the candidate receiving end, so as to establish a connection of a target application with the target receiving end. In this embodiment of the present invention, a problem that a terminal cannot find, without relying on support from an LBS server, another terminal that runs a same application in a local scope or an adjacent area (in a BLUETOOTH or Wi-Fi scope) is resolved, so that a terminal can pertinently find, without support from an LBS server, another terminal that runs a same application or service, thereby implementing mobile data exchange between terminals.

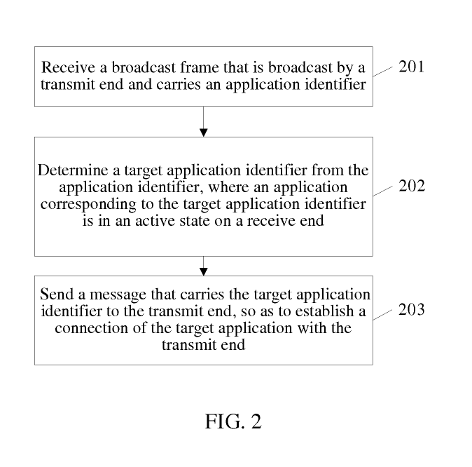

This embodiment of the present invention provides another terminal search method. As shown in FIG. 2, the method includes the following steps.

201. Receive a broadcast frame that is broadcast by a sending end and carries an application identifier.

202. Determine a target application identifier from the application identifier, where an application corresponding to the target application identifier is in an active state on a receiving end.

203. Send a message that carries the target application identifier to the sending end, so as to establish a connection of the target application with the sending end.

In the terminal search method provided in this embodiment of the present invention, a receiving end receives a broadcast frame that is broadcast by a sending end and carries an application identifier; determines a target application identifier from the application identifier, where an application corresponding to the target application identifier is in an active state on the receiving end; and then sends a message that carries the target application identifier to the sending end, so as to establish a connection of the target application with the sending end. In this embodiment of the present invention, a problem in the prior art that a terminal cannot find, without relying on support from an LBS server, another terminal that runs a same application in a local scope or an adjacent area (in a BLUETOOTH or Wi-Fi scope) is resolved, so that a terminal can pertinently find, without support from an LBS server, another terminal that runs a same application or service, thereby implementing mobile data exchange between terminals.

### Embodiment 2

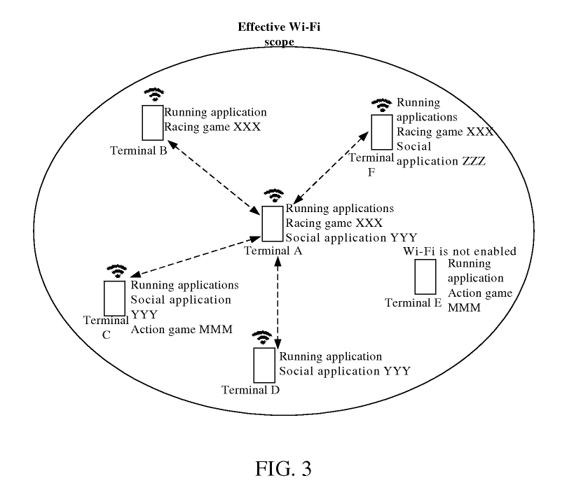

FIG. 3 shows a scenario instance of implementing Wi-Fi device discovery in the present invention. For example, in any crowded place, such as a bus, a subway train, a railway station, a shuttle, a shopping mall, a bank, a hospital, a school, and a company, a user takes out a mobile phone (terminal A) of the user, enables Wi-Fi, and starts a game/social application; and then a screen of the mobile phone automatically displays a nearby terminal (mobile phone/pad) that runs a same game/social application. The user may choose to interconnect with a certain stranger by using Wi-Fi to play an online game, join a pitched multiplayer game, or make some friends by using the social application.

This embodiment of the present invention provides a terminal search method, which is specific to a social application (Social App), that is, a method of an application (APP) supporting application/service type discovery. Data exchange can be implemented by means of application/service type discovery. A Wi-Fi application register client (WAR-C) is added into a social application, and a Wi-Fi application register server (WAR-S) is added into a Wi-Fi module/Wi-Fi drive of a terminal.

A WAR-S on a sending end stores a first application identifier list, where an application corresponding to each application identifier in the first application identifier list is in an active state.

When an application is started, the application automatically registers the application identifier and a process identifier corresponding to the application into the first application identifier list of the sending end by using a WAR-C on the sending end.

Alternatively, when an application is started, a user manually triggers and uses a WAR-C on the sending end to register the application identifier and a process identifier corresponding to the application into the first application identifier list of the sending end.

In addition, optionally, an application does not need to be started, and a user directly and manually registers an identifier of an application that needs to be discovered into the first application identifier list of the sending end.

Optionally, after the application successfully performs registration into the first application identifier list of the sending end, the WAR-S returns a corresponding application register success message to the WAR-C.

A receiving end also stores a first application identifier list on a WAR-S on the receiving end, where an application corresponding to each application identifier in the first application identifier list of the receiving end is in an active state. Registration of the application identifier into the first application identifier list of the receiving end is the same as that in the first application identifier list of the sending end, and details are not repeatedly described herein.

The first application identifier list of the sending end and that on the receiving end are dynamic tables and are continuously and dynamically updated according to startup of an application.

When the sending end is performing a terminal search, as shown in FIG. 4, specific steps are as follows.

301. Acquire an application identifier from the first application identifier list stored on the sending end.

302. The sending end broadcasts a broadcast frame that carries the application identifier.

It may be as follows. After an application identifier is successfully registered into the first program identifier list, the sending end proactively sends a broadcast frame that includes all application identifiers in the first program identifier list, where the broadcast frame may be a probe request frame, the probe request frame is sent periodically, and a specified number of probe request frames are consecutively sent in each period, so as to discover nearby terminals that run a same application as many as possible.

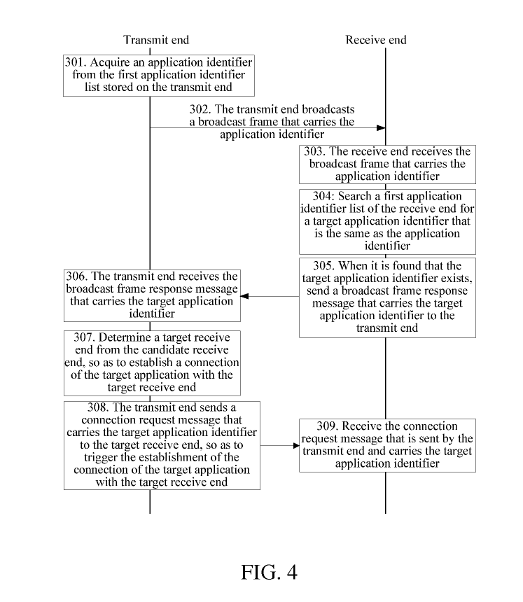

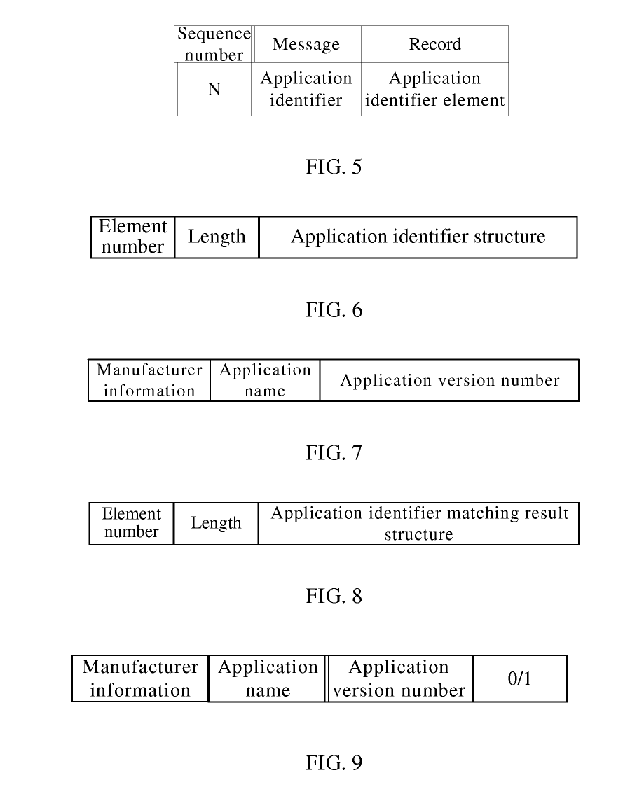

FIG. 5 shows a format of the probe request frame, including a sequence number of an application in the probe request frame, a corresponding application identifier, and an application identifier element. FIG. 6 shows a structure of the application identifier element, including a number and a length of the application identifier element and an application identifier structure. FIG. 7 shows a schematic diagram of content included in the application identifier structure, including manufacturer information, an application name, and an application version number.

303. A receiving end receives the broadcast frame that carries the application identifier.

Specifically, because the sending end sends the broadcast frame, at least one candidate receiving end receives the broadcast frame, and after receiving the broadcast frame, the candidate receiving end performs specific operations described in steps 304-305.

304: Search a first application identifier list of the receiving end for a target application identifier that is the same as the application identifier.

After receiving the probe request frame, the receiving end parses the application identifier in the probe request frame and queries whether a same application identifier exists in the first application identifier list at a local end, where the same application identifier is the target application identifier.

305. When it is found that the target application identifier exists, send a broadcast frame response message that carries the target application identifier to the sending end.

The broadcast frame response message may be a probe response frame, where the probe response frame carries an identifier indicating that application matching succeeds. FIG. 8 shows a structure of an application identifier result extended in the probe response frame. FIG. 9 shows a schematic diagram of content included in a structure of an application identifier matching result, where 0 and 1 indicate a matching result, 1 indicates that a same application exists and matching succeeds, and 0 indicates that no same application exists and matching fails.

Meanwhile, the receiving end notifies a target application at the local end of a list of nearby terminals that run the same application.

In an embodiment, when it is found that no target application identifier exists, no response frame is returned. Certainly, the sending end may also be notified, in a manner of returning a response frame, that no target application identifier exists.

306. The sending end receives the broadcast frame response message that carries the target application identifier.

The sending end receives broadcast frame response messages sent by all candidate receiving ends and notifies the target application at the local end of a list of nearby terminals that run the same application, so that the sending end selects a target receiving end from the candidate receiving ends.

307. Determine a target receiving end from the candidate receiving end, so as to establish a connection of the target application with the target receiving end.

A user selects the target receiving end from the candidate receiving end, or the target application automatically selects the target receiving end from the candidate receiving end.

308. The sending end sends a connection request message that carries the target application identifier to the target receiving end, so as to trigger the establishment of the connection of the target application with the target receiving end.

309. Receive the connection request message that is sent by the sending end and carries the target application identifier.

It is as follows. The target receiving end receives the connection request message that is sent by the sending end and carries the target application identifier, and after the connection is established successfully, the target application on two terminals can perform an online service operation.

Optionally, this embodiment further provides a method for the user to manually stop the terminal search. If the user finds that no terminal with the same application identifier is found after a period of time or sufficient terminals with the same application identifier have been found in a short period of time, the user may press a “stop” key or send an instruction similar to an instruction for stopping the terminal search. Then the WAR-C on the sending end sends an identifier of a corresponding process for stopping searching for the application to the WAR-S on the sending end, an identifier of the application for which the search is stopped is deleted from the first application identifier list, and the corresponding probe request frame no longer carries the identifier of the application for which the search is stopped.

Optionally, this embodiment further provides a processing method for keeping-alive and deregistration between a WAR-C and a WAR-S on a terminal. After an application successfully performs registration into a first application identifier list, the WAR-S on the terminal sets one corresponding timer for each application. When no keep-alive message that is sent by the WAR-C on the terminal and corresponds to the application is received after time specified by the timer is reached, it is considered that the application terminates unexpectedly. Then information related to the application is deleted from the first application identifier list. In addition, after the application successfully performs registration into the first application identifier list, the WAR-C on the terminal starts to send a keep-alive message to the WAR-S, and the WAR-S returns a response message for the keep-alive message. When the application is closed/exits or a user manually stops searching for the application, the WAR-C on the terminal initiates a deregistration request to the WAR-S, where the request carries a process identifier corresponding to the application, so as to instruct the WAR-S on the terminal to delete the information related to the application from the first application identifier list. After receiving the deregistration request, the WAR-S deletes the information related to the application from the first application identifier list and returns a deregistration success response.

In the foregoing method, Wi-Fi is used as a bearer protocol for application discovery and subsequent data transmission. BLUETOOTH may also be used for bearing, where a process is basically the same as a process in a Wi-Fi bearer manner. A difference lies in that an extended module in a Social APP is a BLUETOOTH Application Register Client (BAR-C), whereas an extended module in a BLUETOOTH module/drive is a BLUETOOTH Application Register Server (BAR-S). In addition, in an APP discovery process, Link Management Protocol (LMP) in a BLUETOOTH protocol needs to be extended. For example, an application identifier is carried in a sent LMP_host_connection_request (host connection request frame), and a target application matching identifier and a Personal Identification Number (PIN) that is required for BLUETOOTH pairing are carried in a sent LMP_Accepted (accepted response frame), so that during subsequent establishment of a BLUETOOTH connection, the BAR-S in the BLUETOOTH module can directly use a PIN code, which is obtained by parsing, to perform pairing, without a need to manually enter the PIN code.

This embodiment of the present invention further provides a terminal search method, where the method can be applied to a process of discovering an existing/legacy application (Legacy APP), and the existing application is an application that does not support a social function. In this embodiment of the present invention, a social function in a neighboring area can also be implemented for the existing application.

Similarly, a WAR-S is added into a Wi-Fi module/Wi-Fi drive of a terminal.

The WAR-S on the terminal stores a second application identifier list, where a state flag is set for each application identifier in the second application identifier list, and the state flag is used to indicate whether an application is in an active state or an inactive state.

A user manually triggers registration of certain application identifiers of which data exchange is expected into the second application identifier list of the terminal; alternatively, when the terminal is delivered from a factory, a manufacturer registers certain application identifiers of which data exchange is expected into the second application identifier list of the terminal in advance, and state flags corresponding to the application identifiers are set to the inactive state by default, where the inactive state means that the applications are not in an active state.

When an application is started, the application registers with a process manager in an operating system of the terminal. The WAR-S on the terminal performs polling on the process manager in the operating system of the terminal to query whether the current system of the terminal runs an application that is the same as that in the second application identifier list of the terminal. If yes, a state flag, which corresponds to the same application, in the second application identifier list is set to the active state, and a process identifier corresponding to the application is recorded in the second application identifier list.

The second application identifier list is a dynamic table and is continuously and dynamically updated according to registration and startup of an application.

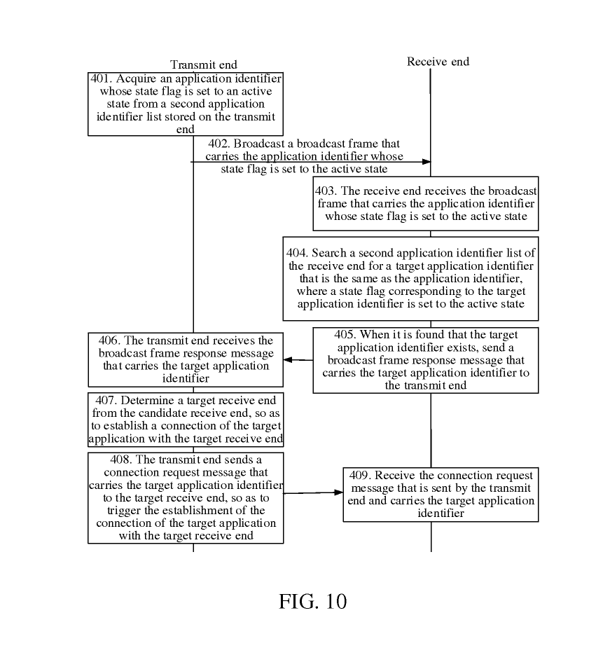

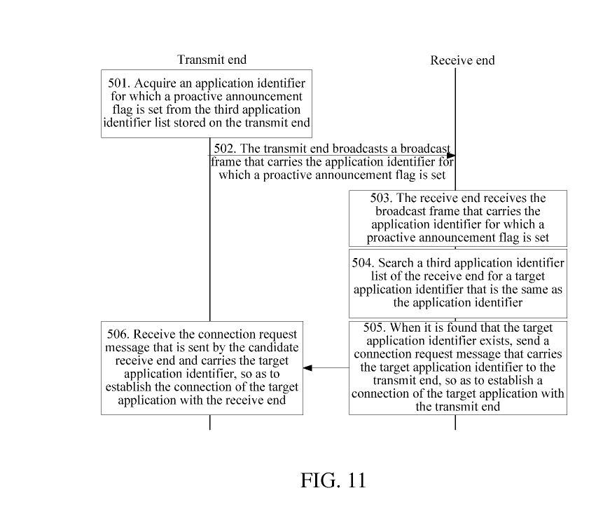

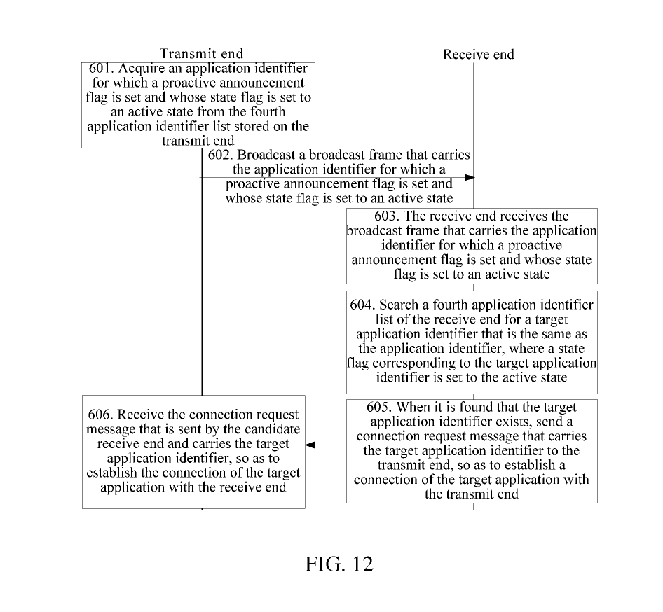

When a sending end is performing a terminal search, as shown in FIG. 10, specific steps are as follows.

401. Acquire an application identifier whose state flag is set to an active state from a second application identifier list stored on the sending end.

A user proactively triggers a device search, and the sending end receives, from the user, a discovery instruction for discovering a target application, where the instruction carries a process identifier corresponding to the target application that needs to be discovered. The sending end determines, according to the process identifier, whether the target application exists in the second application identifier list. If yes, the sending end sends a broadcast frame that carries a target application identifier.

402. The sending end broadcasts a broadcast frame that carries the application identifier whose state flag is set to the active state.

The broadcast frame may be a probe request frame, the probe request frame may be sent periodically, and a specified number of probe request frames may be consecutively sent in each period, so as to discover nearby terminals that run a same application as many as possible. A format of the probe request frame is shown in FIG. 5, FIG. 6, or FIG. 7.

403. A receiving end receives the broadcast frame that carries the application identifier whose state flag is set to the active state.

Specifically, because the sending end sends the broadcast frame, at least one candidate receiving end receives the broadcast frame, and after receiving the broadcast frame, the candidate receiving end performs specific operations described in steps 404-405.

404. Search a second application identifier list of the receiving end for a target application identifier that is the same as the application identifier, where a state flag corresponding to the target application identifier is set to the active state.

After receiving the probe request frame, the receiving end parses the target application identifier in the probe request frame and queries whether the target application identifier exists in the second application identifier list at a local end, where the state flag corresponding to the target application identifier is set to the active state.

405. When it is found that the target application identifier exists, send a broadcast frame response message that carries the target application identifier to the sending end.

The broadcast frame response message is a probe response frame, and its format is shown in FIG. 8 or FIG. 9. Meanwhile, the receiving end notifies a target application at the local end of a list of nearby terminals that run the same application.

In an embodiment, when it is found that no target application identifier exists, no response frame is returned.

406. The sending end receives the broadcast frame response message that carries the target application identifier.

After receiving probe response frames sent by all candidate receiving ends, the sending end notifies the target application at the local end of a list of nearby terminals that run the same application, so that the sending end selects a target receiving end from the candidate receiving ends.

407. Determine a target receiving end from the candidate receiving end, so as to establish a connection of the target application with the target receiving end.

The user selects the target receiving end from the candidate receiving end, or the target application automatically selects the target receiving end from the candidate receiving end.

408. The sending end sends a connection request message that carries the target application identifier to the target receiving end, so as to trigger the establishment of the connection of the target application with the target receiving end.

409. Receive the connection request message that is sent by the sending end and carries the target application identifier.

It is as follows. The target receiving end receives the connection request message that is sent by the sending end and carries the target application identifier, and after the connection is established successfully, the target application on two terminals can perform an online service operation.

Optionally, this embodiment further provides a method for the user to manually stop the terminal search. If the user finds that no terminal with the target application identifier is found after a period of time or sufficient terminals with the target application identifier have been found in a short period of time, the user may press a “stop” key or send an instruction similar to an instruction for stopping the terminal search, so as to send an identifier of a corresponding process for stopping searching for the target application to the WAR-S on the sending end, and information related to the target application for which the search is stopped is deleted from the second application identifier list.

Optionally, this embodiment further provides a processing method for keeping-alive and deregistration of an application on a terminal. After an application successfully performs registration into a second application identifier list, a WAR-S on the terminal sets one corresponding timer for each application. When no keep-alive message that is sent by a process manager on the terminal and corresponds to the application is received after time specified by the timer is reached, it is considered that the application terminates unexpectedly. Then information related to the application is deleted from the second application identifier list. In addition, after the application successfully performs registration into an application identifier list, the process manager on the terminal starts to send a keep-alive message to the WAR-S, and the WAR-S returns a response message for the keep-alive message. When the application is closed/exits or a user manually stops application discovery, the process manager on the terminal initiates a deregistration request to the WAR-S, where the request carries a process identifier corresponding to the application, so as to instruct the WAR-S on the terminal to delete the information related to the application from the second application identifier list. After receiving the deregistration request, the WAR-S deletes the information related to the application from the application identifier list and returns a deregistration success response.

In this embodiment, BLUETOOTH may also be used as a bearer protocol for application discovery and subsequent data exchange.

This embodiment of the present invention further provides a terminal search method, which is specific to a Social APP, that is, a method of an application supporting application/service type discovery. A social function can be implemented by means of application/service type discovery. A Wi-Fi application register client WAR-C is added into a social application, and a Wi-Fi application register server WAR-S is added into a Wi-Fi module/Wi-Fi drive of a terminal.

A WAR-S on a sending end stores a third application identifier list, where an application corresponding to each application identifier in the third application identifier list is in an active state, and a proactive announcement flag is set for at least one application identifier in the third application identifier list.

When an application is started, the application automatically registers the application identifier, a proactive announcement flag corresponding to the application identifier, and a process identifier corresponding to the application into the third application identifier list of the sending end by using a WAR-C on the sending end.

Alternatively, when an application is started, a user manually triggers and uses a WAR-C on the sending end to register the application identifier, a proactive announcement flag corresponding to the application identifier, and a process identifier corresponding to the application into the third application identifier list of the sending end.

Optionally, after the application successfully performs registration into the third application identifier list of the sending end, the WAR-S on the sending end returns a corresponding application register success message to the WAR-C on the sending end.

A receiving end also stores a third application identifier list on a WAR-S on the receiving end, where an application corresponding to each application identifier in the third application identifier list of the receiving end is in an active state.

The third application identifier list is a dynamic table and is continuously and dynamically updated according to registration and startup of an application.

When the sending end is performing a terminal search, as shown in FIG. 11, specific steps are as follows.

501. Acquire an application identifier for which a proactive announcement flag is set from the third application identifier list stored on the sending end.

502. The sending end broadcasts a broadcast frame that carries the application identifier for which a proactive announcement flag is set.

It may be as follows. After an application identifier is successfully registered into the third application identifier list, an application identifier with a proactive announcement flag in the third application identifier list is sent to a receiving end by using the broadcast frame, where the broadcast frame is sent periodically, and a specified number of broadcast frames are consecutively sent in each period, so as to discover nearby terminals that run a same application as many as possible. A format of the broadcast frame is the same as the format of the probe request frame shown in FIG. 5, FIG. 6, or FIG. 7.

503. The receiving end receives the broadcast frame that carries the application identifier for which a proactive announcement flag is set.

Specifically, because the sending end sends the broadcast frame, at least one candidate receiving end receives the broadcast frame, and after receiving the broadcast frame, the candidate receiving end performs specific operations described in steps 504-505.

504: Search a third application identifier list of the receiving end for a target application identifier that is the same as the application identifier.

After receiving the probe request frame, the receiving end parses the application identifier in the probe request frame and queries whether a same application identifier exists in the third application identifier list at a local end, where the same application identifier is the target application identifier.

Meanwhile, the receiving end notifies a target application at the local end of a list of nearby terminals that run the same application.

Optionally, after receiving the broadcast frame, the receiving end searches the third application identifier list of the receiving end for a candidate application identifier that is the same as the application identifier, and sends a unicast frame that carries the candidate application identifier to the sending end; after receiving the unicast frame that is sent by the candidate receiving end and carries the candidate application identifier, the sending end determines a target application identifier from the candidate application identifier, where the target application identifier is included in the third application identifier list of the sending end, and then sends a unicast frame response message that carries the target application identifier to the receiving end; and the receiving end receives the unicast frame response message that is sent by the sending end and carries the target application identifier, and acquires the target application identifier.

In addition, the sending end notifies the target application at the local end of a list of nearby terminals that run the same application, so that the sending end can learn that other terminals also run the same application.

A format of the unicast frame is the same as the format of the probe request frame shown in FIG. 5, FIG. 6, or FIG. 7, and a format of the unicast response frame is the same as the format of the probe response frame shown in FIG. 8 or FIG. 9.

505. When it is found that the target application identifier exists, send a connection request message that carries the target application identifier to the sending end, so as to establish a connection of the target application with the sending end.

A user selects a sending end from the terminal list, or the target application automatically selects a sending end from the terminal list, and sends the connection request message that carries the target application identifier to the sending end for performing connection (for example, WiFi Direct connection), so as to establish a connection of the target application with the sending end.

506. Receive the connection request message that is sent by the candidate receiving end and carries the target application identifier, so as to establish the connection of the target application with the receiving end.

After the connection is established successfully, the target application on two terminals can perform an online service operation.

Optionally, a method for the user to manually stop the terminal search may also be adopted in this embodiment. If the user finds that no terminal with the target application identifier is found after a period of time or sufficient terminals with the target application identifier have been found in a short period of time, the user may press a “stop” key or send an instruction similar to an instruction for stopping the terminal search. Then the WAR-C on the sending end sends an identifier of a corresponding process for stopping discovering the application to the WAR-S on the sending end, an identifier of the application for which the search is stopped is deleted from the third application identifier list of the sending end, and the corresponding probe request frame no longer carries the identifier of the application for which the search is stopped.

Optionally, this embodiment further provides a processing method for keeping-alive and deregistration between a WAR-C and a WAR-S on a terminal. After an application successfully performs registration into a third application identifier list, the WAR-S on the terminal sets one corresponding timer for each application. When no keep-alive message that is sent by the WAR-C on the terminal and corresponds to the application is received after time specified by the timer is reached, it is considered that the application terminates unexpectedly. Then information related to the application is deleted from the third application identifier list. In addition, after the application successfully performs registration into the third application identifier list, the WAR-C on the terminal starts to send a keep-alive message to the WAR-S, and the WAR-S returns a response message for the keep-alive message. When the application is closed/exits or a user manually stops searching for the application, the WAR-C on the terminal initiates a deregistration request to the WAR-S, where the request carries a process identifier corresponding to the application, so as to instruct the WAR-S on the terminal to delete the information related to the application from the third application identifier list. After receiving the deregistration request, the WAR-S deletes the information related to the application from the first application identifier list and returns a deregistration success response.

This embodiment of the present invention further provides a terminal search method, where the method is applied to a process of discovering an existing/legacy application, and the existing application is an application that does not support a social function. In this embodiment of the present invention, a social function in a neighboring area can also be implemented for the existing application.

Similarly, a WAR-S is added into a Wi-Fi module/Wi-Fi drive of a terminal.

A WAR-S on a sending end stores a fourth application identifier list, where a state flag is set for each application identifier in the fourth application identifier list, the state flag is used to indicate whether an application is in an active state or an inactive state, and a proactive announcement flag is set for at least one application identifier in the fourth application identifier list.

A user manually triggers registration of certain application identifiers of which data exchange is expected into the fourth application identifier list of the terminal; alternatively, when the terminal is delivered from a factory, a manufacturer registers certain application identifiers of which data exchange is expected and proactive announcement flags corresponding to the application identifiers into the fourth application identifier list of the terminal in advance, and state flags corresponding to the application identifiers are set to the inactive state by default, where the inactive state means that the applications are not in an active state.

When an application is started, the application registers with a process manager in an operating system of the terminal. The WAR-S on the terminal performs polling on the process manager in the operating system of the terminal to query whether the current system of the terminal runs an application that is the same as that in the fourth application identifier list of the terminal. If yes, a state flag, which corresponds to the same application, in the fourth application identifier list is set to the active state, and a process identifier corresponding to the application is recorded in the fourth application identifier list.

The fourth application identifier list is a dynamic table and is continuously and dynamically updated according to registration and startup of an application.

When the sending end is performing a terminal search, as shown in FIG. 12, specific steps are as follows.

601. Acquire an application identifier for which a proactive announcement flag is set and whose state flag is set to an active state from the fourth application identifier list stored on the sending end.

602. The sending end broadcasts a broadcast frame that carries the application identifier for which a proactive announcement flag is set and whose state flag is set to an active state.

The broadcast frame may be a probe request frame, the probe request frame may be sent periodically, and a specified number of probe request frames may be consecutively sent in each period, so as to discover nearby terminals that run a same application as many as possible. A format of the probe request frame is shown in FIG. 5, FIG. 6, or FIG. 7.

603. A receiving end receives the broadcast frame that carries the application identifier for which a proactive announcement flag is set and whose state flag is set to an active state.

Specifically, because the sending end sends the broadcast frame, at least one candidate receiving end receives the broadcast frame, and after receiving the broadcast frame, the candidate receiving end performs specific operations described in steps 604-605.

604. Search a fourth application identifier list of the receiving end for a target application identifier that is the same as the application identifier, where a state flag corresponding to the target application identifier is set to the active state.

After receiving the probe request frame, the receiving end parses the application identifier in the probe request frame and queries whether a same application identifier exists in the fourth application identifier list at a local end, where the same application identifier is the target application identifier.

Meanwhile, the receiving end notifies a target application at the local end of a list of nearby terminals that run the same application.

Optionally, after receiving the broadcast frame, the receiving end searches the fourth application identifier list for a candidate application identifier that is the same as the application identifier, and sends a unicast frame that carries the candidate application identifier to the sending end; after receiving the unicast frame that is sent by the candidate receiving end and carries the candidate application identifier, the sending end determines a target application identifier from the candidate application identifier, where the target application identifier is included in the fourth application identifier list of the sending end, and then sends a unicast frame response message that carries the target application identifier to the receiving end; and the receiving end receives the unicast frame response message that is sent by the sending end and carries the target application identifier, and acquires the target application identifier.

In addition, the sending end notifies the target application at the local end of a list of nearby terminals that run the same application, so that the sending end can learn that other terminals also run the same application.

A format of the unicast frame is the same as the format of the probe request frame shown in FIG. 5, FIG. 6, or FIG. 7, and a format of the unicast response frame is the same as the format of the probe response frame shown in FIG. 8 or FIG. 9.

605. When it is found that the target application identifier exists, send a connection request message that carries the target application identifier to the sending end, so as to establish a connection of the target application with the sending end.

A user selects a sending end from the terminal list, or the target application automatically selects a sending end from the terminal list, and sends the connection request message that carries the target application identifier to the sending end for performing connection, so as to trigger the establishment of a connection of the target application with the sending end.

606. Receive the connection request message that is sent by the candidate receiving end and carries the target application identifier, so as to establish the connection of the target application with the receiving end.

After the connection is established successfully, the target application on two terminals can perform an online service operation.

Optionally, a method for the user to manually stop the terminal search may also be adopted in this embodiment. If the user finds that no terminal with the target application identifier is found after a period of time or sufficient terminals with the target application identifier have been found in a short period of time, the user may press a “stop” key or send an instruction similar to an instruction for stopping the terminal search, so as to send an identifier of a corresponding process for stopping discovering the application to the WAR-S on the sending end, and the corresponding probe request frame no longer carries an identifier of the application for which discovery is stopped.

Optionally, this embodiment further provides a processing method for keeping-alive and deregistration of an application on a terminal. After an application successfully performs registration into a fourth application identifier list, a WAR-S on the terminal sets one corresponding timer for each application. When no keep-alive message that is sent by a process manager on the terminal and corresponds to the application is received after time specified by the timer is reached, it is considered that the application terminates unexpectedly. Then information related to the application is deleted from the fourth application identifier list. In addition, after the application successfully performs registration into the fourth application identifier list, the process manager on the terminal starts to send a keep-alive message to the WAR-S, and the WAR-S returns a response message for the keep-alive message. When the application is closed/exits or a user manually stops application discovery, the process manager on the terminal initiates a deregistration request to the WAR-S, where the request carries a process identifier corresponding to the application, so as to instruct the WAR-S on the terminal to delete the information related to the application from the fourth application identifier list. After receiving the deregistration request, the WAR-S deletes the information related to the application from the application identifier list and returns a deregistration success response.

The foregoing embodiment of the present invention can be applied to an application discovery process in all short-distance wireless communications.

### Embodiment 3

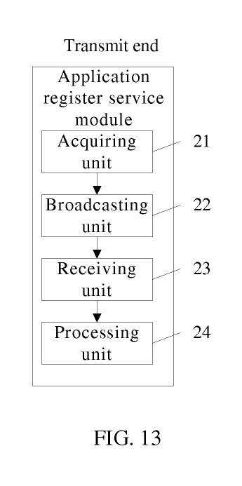

This embodiment of the present invention provides a sending end, as shown in FIG. 13, including an application register service module. The sending end includes an acquiring unit 21, a broadcasting unit 22, a receiving unit 23, and a processing unit 24.

The acquiring unit 21 is configured to acquire an application identifier; the broadcasting unit 22 is configured to broadcast a broadcast frame that carries the application identifier to a receiving end; the receiving unit 23 is configured to receive a message that is sent by a candidate receiving end and carries a target application identifier, where the target application identifier is selected by the candidate receiving end from the application identifier; and the processing unit 24 is configured to determine a target receiving end from the candidate receiving end, so as to establish a connection of a target application with the target receiving end.

This embodiment of the present invention provides a sending end. An application identifier of the sending end is acquired; a broadcast frame that carries the application identifier is broadcast to a receiving end; the sending end receives messages that are sent by candidate receiving ends and carry target application identifiers of the candidate receiving ends, where the target application identifier is selected by the candidate receiving end from the application identifier; and the sending end determines a target receiving end from the candidate receiving end, so as to establish a connection of a target application with the target receiving end. In this embodiment of the present invention, a problem that a terminal cannot find, without relying on support from an LBS server, another terminal that runs a same application in a local scope or an adjacent area (in a BLUETOOTH or Wi-Fi scope) is resolved, so that another terminal that runs a same application or service can be pertinently found without support from an LBS server, thereby implementing mobile data exchange between terminals.

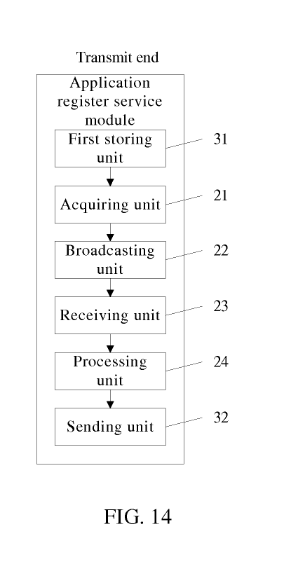

Optionally, as shown in FIG. 14, the sending end further includes a first storing unit 31.

The first storing unit is configured to store a first application identifier list, where an application corresponding to each application identifier in the first application identifier list is in an active state.

The acquiring unit is configured to acquire the application identifier from the first application identifier list stored on the sending end.

The receiving unit is configured to receive a broadcast frame response message that is sent by the candidate receiving end and carries the target application identifier.

The sending end further includes a sending unit 32 configured to send a connection request message that carries the target application identifier to the target receiving end, so as to trigger the establishment of the connection of the target application with the target receiving end.

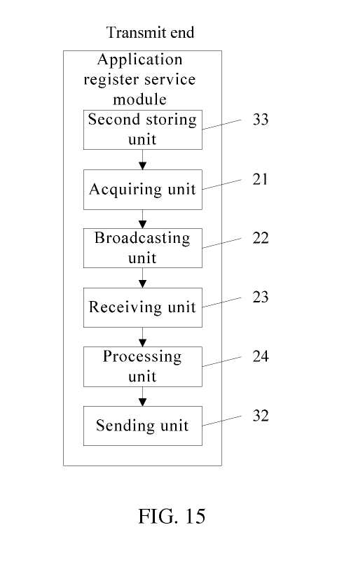

Optionally, as shown in FIG. 15, the sending end further includes a second storing unit 33 configured to store a second application identifier list, where a state flag is set for each application identifier in the second application identifier list, and the state flag is used to indicate whether an application is in an active state or an inactive state.

The acquiring unit is configured to acquire an application identifier whose state flag is set to the active state from the second application identifier list stored on the sending end.

The receiving unit is configured to receive a broadcast frame response message that is sent by the candidate receiving end and carries the target application identifier.

The sending unit is configured to send a connection request message that carries the target application identifier to the target receiving end, so as to trigger the establishment of the connection of the target application with the target receiving end.

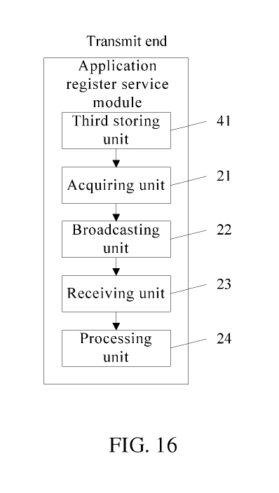

Optionally, as shown in FIG. 16, the sending end further includes a third storing unit 41 configured to store a third application identifier list, where an application corresponding to each application identifier in the third application identifier list is in an active state, and a proactive announcement flag is set for at least one application identifier in the third application identifier list.

The acquiring unit is configured to acquire an application identifier for which a proactive announcement flag is set from the third application identifier list stored on the sending end.

The receiving unit is configured to receive a connection request message that is sent by the candidate receiving end and carries the target application identifier.

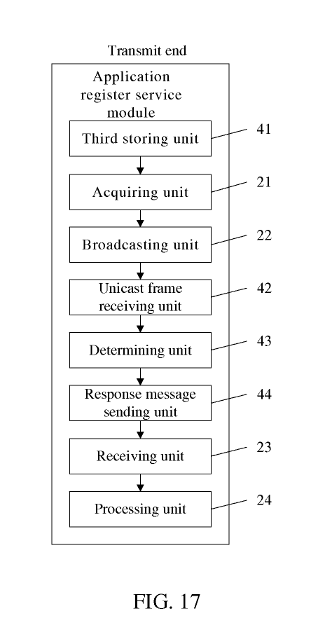

Optionally, as shown in FIG. 17, the sending end further includes a unicast frame receiving unit 42 configured to receive a unicast frame that is sent by the candidate receiving end and carries a candidate application identifier; a determining unit 43 configured to determine a target application identifier from the candidate application identifier, where the target application identifier is included in the third application identifier list, or included in the fourth application list, and a state flag corresponding to the target application identifier is set to the active state; and a response message sending unit 44 configured to send a unicast frame response message that carries the target application identifier to the candidate receiving end.

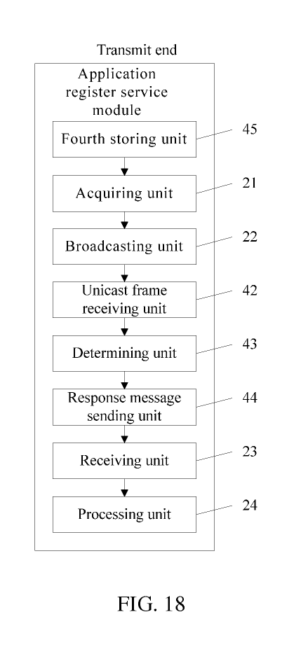

Optionally, as shown in FIG. 18, the sending end further includes a fourth storing unit 45 configured to store a fourth application identifier list, where a state flag is set for each application identifier in the fourth application identifier list, the state flag is used to indicate whether an application is in an active state or an inactive state, and a proactive announcement flag is set for at least one application identifier in the fourth application identifier list.

The acquiring unit is configured to acquire an application identifier for which a proactive announcement flag is set and whose state flag is set to the active state from the fourth application identifier list stored on the sending end.

The receiving unit is configured to receive a connection request message that is sent by the candidate receiving end and carries the target application identifier.

The unicast frame receiving unit is configured to receive a unicast frame that is sent by the candidate receiving end and carries a candidate application identifier.

The determining unit is configured to determine a target application identifier from the candidate application identifier, where the target application identifier is included in the third application identifier list, or included in the fourth application list, and a state flag corresponding to the target application identifier is set to the active state.

The response message sending unit is configured to send a unicast frame response message that carries the target application identifier to the candidate receiving end.

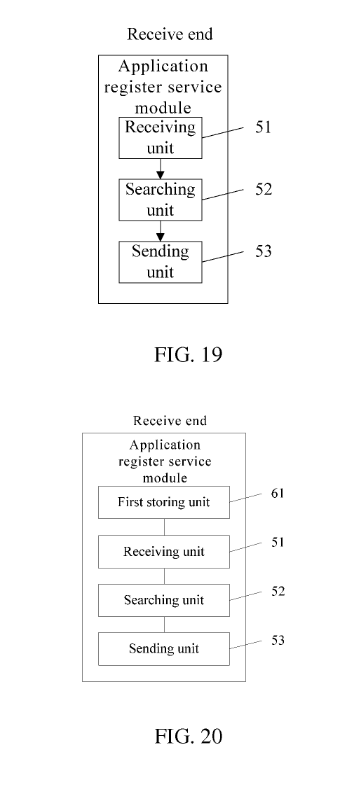

Accordingly, this embodiment of the present invention further provides a receiving end, as shown in FIG. 19, including an application register service module. The receiving end includes a receiving unit 51, a searching unit 52, and a sending unit 53.

The receiving unit 51 is configured to receive a broadcast frame that is broadcast by a sending end and carries an application identifier; the searching unit 52 is configured to determine a target application identifier from the application identifier, where an application corresponding to the target application identifier is in an active state on the receiving end; and the sending unit 53 is configured to send a message that carries the target application identifier to the sending end, so as to establish a connection of the target application with the sending end.

This embodiment of the present invention provides a receiving end. The receiving end receives a broadcast frame that is broadcast by a sending end and carries an application identifier, determines a target application identifier from the application identifier, where an application corresponding to the target application identifier is in an active state on the receiving end, and then sends a message that carries the target application identifier to the sending end, so as to establish a connection of the target application with the sending end. In this embodiment of the present invention, a problem in the prior art that a terminal cannot find, without relying on support from an LBS server, another terminal that runs a same application in a local scope or an adjacent area (in a BLUETOOTH or Wi-Fi scope) is resolved, so that a terminal can pertinently find, without support from an LBS server, another terminal that runs a same application or service, thereby implementing mobile data exchange between terminals.

Optionally, as shown in FIG. 20, the receiving end further includes a first storing unit 61.

The first storing unit is configured to store a first application identifier list, where an application corresponding to each application identifier in the first application identifier list is in an active state.

The searching unit is configured to search the first application list for a target application identifier that is the same as the application identifier.

The sending unit is configured to send a broadcast frame response message that carries the target application identifier to the sending end.

The receiving unit is further configured to receive a connection request message that is sent by the sending end and carries the target application identifier.

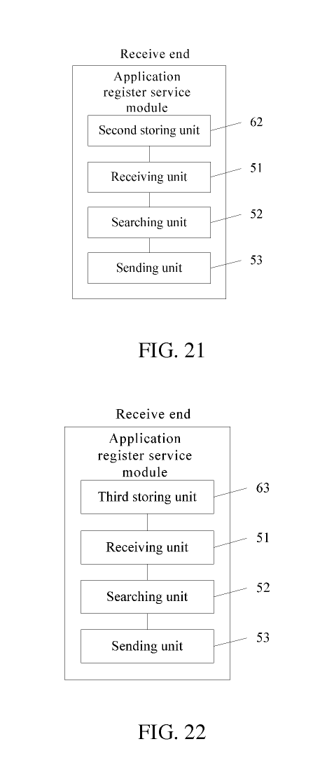

Optionally, as shown in FIG. 21, the receiving end further includes a second storing unit 62 configured to store a second application identifier list, where a state flag is set for each application identifier in the second application identifier list, and the state flag is used to indicate whether an application is in an active state or an inactive state.

The searching unit is configured to search the second application identifier list for a target application identifier that is the same as the application identifier, where a state flag corresponding to the target application identifier is set to the active state.

The sending unit is configured to send a broadcast frame response message that carries the target application identifier to the sending end.

The receiving unit is further configured to receive a connection request message that is sent by the sending end and carries the target application identifier.

Optionally, as shown in FIG. 22, the receiving end further includes a third storing unit 63 configured to store a third application identifier list, where an application corresponding to each application identifier in the third application identifier list is in an active state.

The searching unit is configured to search the third application identifier list for a target application identifier that is the same as the application identifier.

The sending unit is configured to send a connection request message that carries the target application identifier to the sending end.

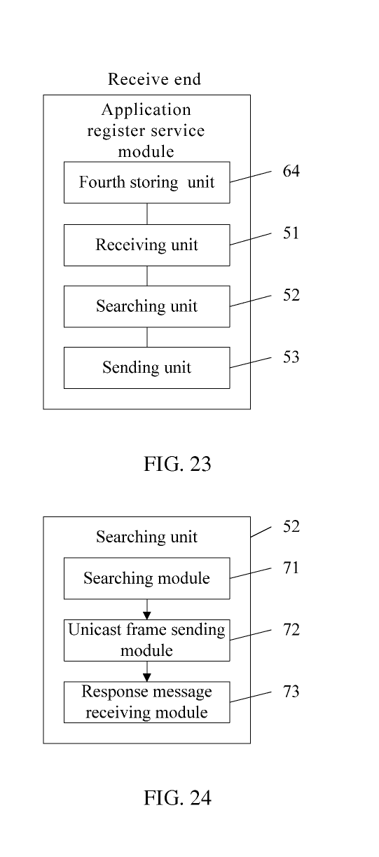

Optionally, as shown in FIG. 23, the receiving end further includes a fourth storing unit 64 configured to store a fourth application identifier list, where a state flag is set for each application identifier in the fourth application identifier list, and the state flag is used to indicate whether an application is in an active state or an inactive state.

The searching unit is configured to search the fourth application identifier list for a target application identifier that is the same as the application identifier, where a state flag corresponding to the target application identifier is set to the active state.

The sending unit is configured to send a connection request message that carries the target application identifier to the sending end.

Optionally, as shown in FIG. 24, the searching unit in FIG. 22 and FIG. 23 further includes a searching module 71, a unicast frame sending module 72, and a response message receiving module 73.

The searching module 71 is configured to search the third application identifier list for a candidate application identifier that is the same as the application identifier; or configured to search the fourth application identifier list for a candidate application identifier that is the same as the application identifier, where a state flag corresponding to the candidate application identifier is set to the active state; the unicast frame sending module 72 is configured to send a unicast frame that carries the candidate application identifier to the sending end; and the response message receiving module 73 is configured to receive a unicast frame response message that is sent by the sending end and carries a target application identifier, and acquire the target application identifier.

In addition, each technology, system, apparatus, and method that are described in the foregoing embodiments and technical features described in the embodiments can be combined to form other modules, methods, apparatuses, systems, and technologies without departing from the spirit and principle of the present invention. These modules, methods, apparatuses, systems, and technologies formed by means of combination according to the description of the embodiments of the present invention shall fall within the protection scope of the present invention.

A person skilled in the art should understand that each of the foregoing units or steps in the present invention can be implemented by using a general computing apparatus. They can be centralized on a single computing apparatus or distributed on a network formed by multiple computing apparatuses. Optionally, they can be implemented by using program code that can be executed by a computing apparatus, and therefore they can be stored in a storage apparatus and executed by the computing apparatus. Alternatively, they are manufactured into various circuit modules, or multiple units or steps of them are manufactured into a single circuit module for implementation. In this way, the present invention is not limited to any specific combination of hardware and software.

The foregoing description is merely specific implementation manners of the present invention, but is not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A terminal search method, comprising:
acquiring an application identifier;
broadcasting a broadcast frame that carries the application identifier to a receiving end;
receiving a message that is sent by a candidate receiving end and carries a target application identifier, wherein the target application identifier is selected by the candidate receiving end from the application identifier; and
determining a target receiving end from the candidate receiving end to establish a connection of a target application with the target receiving end.

2. The method according to claim 1, wherein a sending end stores a first application identifier list, and an application corresponding to each application identifier in the first application identifier list is in an active state, and wherein acquiring the application identifier comprises acquiring the application identifier from the first application identifier list.

3. The method according to claim 1, wherein a sending end stores a second application identifier list, a state flag is set for each application identifier in the second application identifier list, and the state flag is used to indicate whether an application is in an active state or an inactive state, and wherein acquiring the application identifier comprises acquiring an application identifier whose state flag is set to the active state from the second application identifier list.

4. The method according to claim 2, wherein receiving the message that is sent by the candidate receiving end and carries the target application identifier comprises receiving a broadcast frame response message that is sent by the candidate receiving end and carries the target application identifier.

5. The method according to claim 2, wherein after determining the target receiving end from the candidate receiving end, the method further comprises sending a connection request message that carries the target application identifier to the target receiving end to trigger the establishment of the connection of the target application with the target receiving end.

6. The method according to claim 1, wherein a sending end stores a third application identifier list, an application corresponding to each application identifier in the third application identifier list is in an active state, and a proactive announcement flag is set for at least one application identifier in the third application identifier list, and wherein acquiring the application identifier comprises acquiring an application identifier for which a proactive announcement flag is set from the third application identifier list.

7. The method according to claim 1, wherein a sending end stores a fourth application identifier list, a state flag is set for each application identifier in the fourth application identifier list, the state flag is used to indicate whether an application is in an active state or an inactive state, and a proactive announcement flag is set for at least one application identifier in the fourth application identifier list, and wherein acquiring the application identifier comprises acquiring an application identifier for which a proactive announcement flag is set and whose state flag is set to the active state from the fourth application identifier list.

8. The method according to claim 6, wherein receiving the message that is sent by the candidate receiving end and carries the target application identifier comprises receiving a connection request message that is sent by the candidate receiving end and carries the target application identifier.

9. The method according to claim 6, wherein before receiving the message that is sent by the candidate receiving end and carries the target application identifier, the method further comprises:
receiving a unicast frame that is sent by the candidate receiving end and carries a candidate application identifier;
determining a target application identifier from the candidate application identifier, wherein the target application identifier is comprised in the third application identifier list, or comprised in the fourth application list, and a state flag corresponding to the target application identifier is set to the active state; and
sending a unicast frame response message that carries the target application identifier to the candidate receiving end.

10. A terminal search method, comprising:
receiving a broadcast frame that is broadcast by a sending end and carries an application identifier;
determining a target application identifier from the application identifier, wherein an application corresponding to the target application identifier is in an active state on a receiving end; and
sending a message that carries the target application identifier to the sending end to establish a connection of the target application with the sending end.

11. The method according to claim 10, wherein the receiving end stores a first application identifier list, and an application corresponding to each application identifier in the first application identifier list is in an active state, and wherein determining the target application identifier from the application identifier, wherein the application corresponding to the target application identifier is in the active state on the receiving end comprises searching the first application list for a target application identifier that is the same as the application identifier.

12. The method according to claim 10, wherein the receiving end stores a second application identifier list, a state flag is set for each application identifier in the second application identifier list, and the state flag is used to indicate whether an application is in an active state or an inactive state, and wherein determining the target application identifier from the application identifier, wherein the application corresponding to the target application identifier is in the active state on the receiving end comprises searching the second application identifier list for a target application identifier that is the same as the application identifier, wherein a state flag corresponding to the target application identifier is set to the active state.

13. The method according to claim 11, wherein sending the message that carries the target application identifier to the sending end comprises sending a broadcast frame response message that carries the target application identifier to the sending end.

14. The method according to claim 11, wherein after sending the message that carries the target application identifier to the sending end, the method further comprises receiving a connection request message that is sent by the sending end and carries the target application identifier.

15. The method according to claim 10, wherein the receiving end stores a third application identifier list, and an application corresponding to each application identifier in the third application identifier list is in an active state, and wherein determining the target application identifier from the application identifier, wherein the application corresponding to the target application identifier is in the active state on the receiving end comprises searching the third application identifier list for a target application identifier that is the same as the application identifier.

16. The method according to claim 10, wherein the receiving end stores a fourth application identifier list, a state flag is set for each application identifier in the fourth application identifier list, and the state flag is used to indicate whether an application is in an active state or an inactive state, and wherein determining the target application identifier from the application identifier, wherein the application corresponding to the target application identifier is in the active state on the receiving end comprises searching the fourth application identifier list for a target application identifier that is the same as the application identifier, wherein a state flag corresponding to the target application identifier is set to the active state.

17. The method according to claim 15, wherein sending the message that carries the target application identifier to the sending end comprises sending a connection request message that carries the target application identifier to the sending end.

18. The method according to claim 15, wherein determining the target application identifier from the application identifier, wherein the application corresponding to the target application identifier is in the active state on the receiving end comprises:
searching the third application identifier list for a candidate application identifier that is the same as the application identifier; or
searching the fourth application identifier list for a candidate application identifier that is the same as the application identifier, wherein a state flag corresponding to the candidate application identifier is set to the active state;
sending a unicast frame that carries the candidate application identifier to the sending end;
receiving a unicast frame response message that is sent by the sending end and carries the target application identifier; and
acquiring the target application identifier.

19. A sending end, comprising:
an application register service module;
an acquiring unit configured to acquire an application identifier;
a broadcasting unit configured to broadcast a broadcast frame that carries the application identifier to a receiving end;
a receiving unit configured to receive a message that is sent by a candidate receiving end and carries a target application identifier, wherein the target application identifier is selected by the candidate receiving end from the application identifier; and
a processing unit configured to determine a target receiving end from the candidate receiving end to establish a connection of a target application with the target receiving end.

20. The sending end according to claim 19, wherein the sending end further comprises a first storing unit configured to store a first application identifier list, and an application corresponding to each application identifier in the first application identifier list is in an active state, and wherein the acquiring unit is configured to acquire an application identifier from the first application identifier list.

21. The sending end according to claim 19, wherein the sending end further comprises a second storing unit configured to store a second application identifier list, a state flag is set for each application identifier in the second application identifier list, and the state flag is used to indicate whether an application is in an active state or an inactive state, and wherein the acquiring unit is configured to acquire an application identifier whose state flag is set to the active state from the second application identifier list.

22. The sending end according to claim 20, wherein the receiving unit is configured to receive a broadcast frame response message that is sent by the candidate receiving end and carries the target application identifier.

23. The sending end according to claim 20, further comprising a sending unit configured to send a connection request message that carries the target application identifier to the target receiving end to trigger the establishment of the connection of the target application with the target receiving end.

24. The sending end according to claim 19, wherein the sending end further comprises a third storing unit configured to store a third application identifier list, an application corresponding to each application identifier in the third application identifier list is in an active state, and a proactive announcement flag is set for at least one application identifier in the third application identifier list, and wherein the acquiring unit is configured to acquire an application identifier for which a proactive announcement flag is set from the third application identifier list.

25. The sending end according to claim 19, wherein the sending end further comprises a fourth storing unit configured to store a fourth application identifier list, a state flag is set for each application identifier in the fourth application identifier list, the state flag is used to indicate whether an application is in an active state or an inactive state, and a proactive announcement flag is set for at least one application identifier in the fourth application identifier list, and wherein the acquiring unit is configured to acquire an application identifier for which a proactive announcement flag is set and whose state flag is set to the active state from the fourth application identifier list.

26. The sending end according to claim 24, wherein the receiving unit is configured to receive a connection request message that is sent by the candidate receiving end and carries the target application identifier.

27. The sending end according to claim 24, further comprising:
a unicast frame receiving unit configured to receive a unicast frame that is sent by the candidate receiving end and carries a candidate application identifier;
a determining unit configured to determine a target application identifier from the candidate application identifier, wherein the target application identifier is comprised in the third application identifier list, or comprised in the fourth application list, and a state flag corresponding to the target application identifier is set to the active state; and
a response message sending unit configured to send a unicast frame response message that carries the target application identifier to the candidate receiving end.

28. A receiving end, comprising:
an application register service module;
a receiving unit configured to receive a broadcast frame that is broadcast by a sending end and carries an application identifier;
a searching unit configured to determine a target application identifier from the application identifier, wherein an application corresponding to the target application identifier is in an active state on the receiving end; and
a sending unit configured to send a message that carries the target application identifier to the sending end to establish a connection of the target application with the sending end.

29. The receiving end according to claim 28, wherein the receiving end further comprises a first storing unit configured to store a first application identifier list, and an application corresponding to each application identifier in the first application identifier list is in an active state, and wherein the searching unit is configured to search the first application list for a target application identifier that is the same as the application identifier.

30. The receiving end according to claim 28, wherein the receiving end further comprises a second storing unit configured to store a second application identifier list, a state flag is set for each application identifier in the second application identifier list, and the state flag is used to indicate whether an application is in an active state or an inactive state, and wherein the searching unit is configured to search the second application identifier list for a target application identifier that is the same as the application identifier, wherein a state flag corresponding to the target application identifier is set to the active state.

31. The receiving end according to claim 29, wherein the sending unit is configured to send a broadcast frame response message that carries the target application identifier to the sending end.

32. The receiving end according to claim 29, wherein the receiving unit is further configured to receive a connection request message that is sent by the sending end and carries the target application identifier.

33. The receiving end according to claim 28, wherein the receiving end further comprises a third storing unit configured to store a third application identifier list, and an application corresponding to each application identifier in the third application identifier list is in an active state, and wherein the searching unit is configured to search the third application identifier list for a target application identifier that is the same as the application identifier.

34. The receiving end according to claim 28, wherein the receiving end further comprises a fourth storing unit configured to store a fourth application identifier list, a state flag is set for each application identifier in the fourth application identifier list, and the state flag is used to indicate whether an application is in an active state or an inactive state, and wherein the searching unit is configured to search the fourth application identifier list for a target application identifier that is the same as the application identifier, wherein a state flag corresponding to the target application identifier is set to the active state.

35. The receiving end according to claim 33, wherein the sending unit is configured to send a connection request message that carries the target application identifier to the sending end.

36. The receiving end according to claim 33, wherein the searching unit comprises:
a searching module configured to search the third application identifier list for a candidate application identifier that is the same as the application identifier; or configured to search the fourth application identifier list for a candidate application identifier that is the same as the application identifier, wherein a state flag corresponding to the candidate application identifier is set to the active state;
a unicast frame sending module configured to send a unicast frame that carries the candidate application identifier to the sending end; and
a response message receiving module configured to receive a unicast frame response message that is sent by the sending end and carries the target application identifier, and acquire the target application identifier.
